(19) United States
(12) Patent Application Publication
(10) Pub. No.: US 2023/0362256 A1
(43) Pub. Date: Nov. 9, 2023

(54) ELECTRONIC DEVICE AND IOT CONTROL INFORMATION SHARING METHOD

(71) Applicant: Samsung Electronics Co., Ltd., Suwon-si (KR)

(72) Inventors: Yoonseok KANG, Suwon-si (KR); Mingyu KIM, Suwon-si (KR); Gajin SONG, Suwon-si (KR); Minkyung HWANG, Suwon-si (KR)

(21) Appl. No.: 18/355,628

(22) Filed: Jul. 20, 2023

Related U.S. Application Data
(63) Continuation of application No. PCT/KR2022/002906, filed on Mar. 2, 2022.

(30) Foreign Application Priority Data
Apr. 6, 2021 (KR) 10-2021-0044834

(51) Int. Cl. H04L 67/125; H04W 8/00

(52) U.S. Cl. CPC H04L 67/125; H04W 8/005

(57) ABSTRACT

An electronic device according to various embodiments comprises: a display; a communication module including communication circuitry; a memory; and a processor operatively connected to the display, the communication module, and the memory, wherein the processor may be configured to: receive, through the communication module, first Internet-of-things (IoT) control information including device information regarding at least one external IoT device generated by an external user device and operation information configured for the at least one external IoT device; identify one or more IoT devices that can be connected on a local network through the electronic device determine based on the received first IoT control information a main device among the one or more identified IoT devices and operation information to be applied to the main device; and generate second IoT control information including device information regarding the main device and the operation information regarding the main device.

### CROSS-REFERENCE TO RELATED APPLICATIONS

This application is a continuation of International Application No. PCT/KR2022/002906 designating the United States, filed on Mar. 2, 2022, in the Korean Intellectual Property Receiving Office and claiming priority to Korean Patent Application No. 10-2021-0044834, filed on Apr. 6, 2021, in the Korean Intellectual Property Office, the disclosures of each of which are incorporated by reference herein in their entireties.

### BACKGROUND

### Field

The disclosure relates to Internet of things (IoT) and, for example, to a method of sharing IoT control information configured by one user device with another user device.

### Description of Related Art

A clouding computing technology may refer to a technology that provides a user with computing resources existing in the location different from the user through a network to provide a computing service such as a server, a storage space, software, or analysis. Clouding computing may be used to process data generated by Internet of things (IoT). Data or content of the user collected by IoT devices may be stored in a cloud server, and a cloud service may be provided to the user through data processing.

A rapidly growing IoT environment allows the user to easily manage and use various devices through the connection between the various devices. In the IoT environment, the user may configure an operation of an IoT device through an application and group operations of several IoT devices to generate one scene.

In the prior art, there was no method of sharing a scene with another user when the scene is generated through a user device in an IoT environment.

### SUMMARY

Embodiments of the disclosure may provide a device that may share a scene (or IoT control information) generated through a user device with another user device and the user device receiving sharing can change and use the scene according to the user and context of the user device.

An electronic device according to various example embodiments includes: a display, a communication module comprising communication circuitry, a memory, and a processor operatively connected to the display, the communication module, and the memory, wherein the processor is configured to: receive first Internet of things (IoT) control information including device information of at least one external IoT device generated by an external user device and operation information configured for the at least one external IoT device through the communication module, identify at least one IoT device which can be connected in a local network through the electronic device, determine a main device among the at least one identified IoT device and operation information to be applied to the main device based on the received first IoT control information, and generate second IoT control information including device information of the main device and operation information of the main device.

A method of converting IoT control information shared with an external user device by an electronic device according to various example embodiments includes: receiving Internet of things (IoT) control information including device information of at least one external IoT device generated by an external user device and operation information configured for the at least one external IoT device, identifying at least one IoT device which can be connected in a local network through the electronic device, determining a main device among the at least one identified IoT device and operation information to be applied to the main device based on the received first IoT control information, and generating second IoT control information including device information of the main device and operation information of the main device.

According to various example embodiments of the disclosure, it is possible to provide an electronic device capable of receiving sharing of IoT control information, changing the IoT control information according to context of the electronic device, and using the same, and a method of sharing IoT control information.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating devices in an IoT environment according to various embodiments;

FIG. 2 is a block diagram illustrating an example electronic device in a network environment according to various embodiments;

FIG. 3 is a block diagram illustrating an example configuration of the electronic device according to various embodiments;

FIG. 4 is a diagram illustrating an example system architecture for IoT control information of an electronic device according to various embodiments;

FIG. 5 is a diagram illustrating an example of sharing and converting IoT control information according to various embodiments;

FIG. 6 is a diagram illustrating an example method of converting IoT control information according to various embodiments;

FIG. 7 is a diagram illustrating an example method of converting IoT control information according to various embodiments;

FIG. 8 is a flowchart illustrating an example method of sharing IoT control information according to various embodiments;

FIG. 9 is a flowchart illustrating an example method of sharing IoT control information according to various embodiments; and

FIGS. 10A and 10B are diagrams illustrating example application screens of an electronic device for controlling IoT devices according to various embodiments.

### DETAILED DESCRIPTION

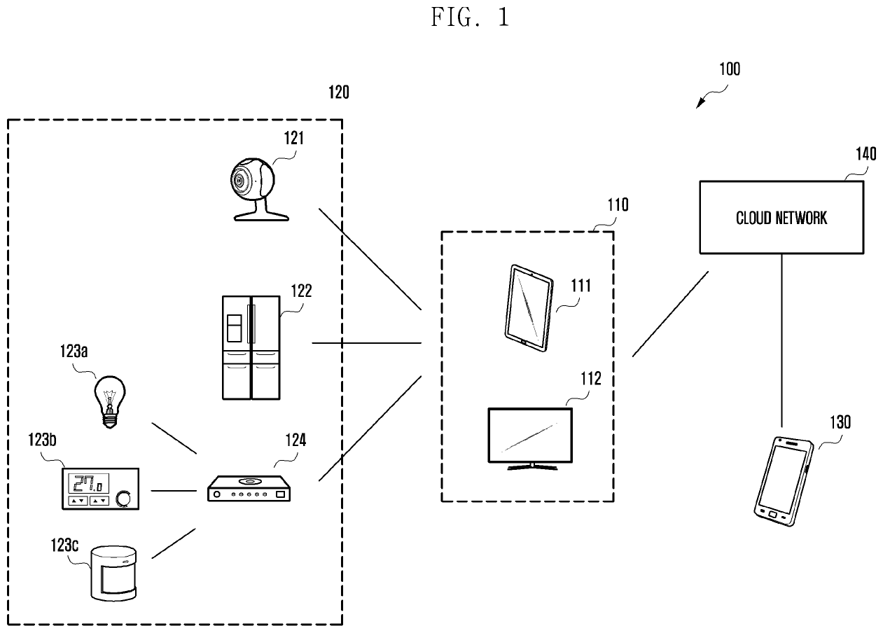

FIG. 1 is a diagram illustrating devices in an IoT environment (or an IoT system) according to various embodiments.

Referring to FIG. 1, an Internet of things (IoT) system 100 may include at least one leaf device 120, at least one hub device 110 (or edge device), a user device 130, and a cloud network 140. For example, the leaf device 120, the hub device 110, and the user device 130 may be disposed at the adjacent location (for example, within home) and connected to the same home network (for example, same access point (AP), and the cloud network 140 may be located remotely but connected to the leaf device 120, the hub device 110, and the user device 130 through the Internet.

In various embodiments of the disclosure, an edge computing service may refer, for example, to a technology that transmits data acquired by the leaf device to the hub device located adjacent to the leaf device in the same home network and provides a series of data processing of the hub device and other services. In various embodiments of the disclosure, a device (for example, a camera 121, a refrigerator 122, a bulb 123a, a digital thermometer 123b, or a motion sensor 123c) acquiring data through a sensor may be referred to as a leaf device, but the leaf device may be referred to by another name such as a client device, an end device, a sensor device, an IoT device, or a slave device in the edge computing service. Further, in various embodiments of the disclosure, the hub device referenced, but the hub device may be referred to as another name such as an edge device, an edge server, a server device, a master device, or a service device in the edge computing service.

In the disclosure, devices are divided into the leaf device 120, the hub device 110, and the user device 130 according to a function or an operation of each device within the IoT system 100, but the same device (for example, a smart phone or a tablet PC) may operate as one of the leaf device 120, the hub device 110, and the user device 130 according to a circumstance. In other words, the name and/or the reference of the device described in various embodiments of the disclosure do not limit functions and/or operations of the corresponding device.

According to various embodiments, the leaf device 120 may be an end point of the IoT system 100 and may collect various pieces of data through a sensor and transmit the data to the hub device 110 or the cloud network 140. Further, the leaf device 120 may perform various operations according to command transmitted from the cloud network 140 or the user device 130. Referring to FIG. 1, the device such as the camera 121, the refrigerator 122, the bulb 123a, the digital thermometer 123b, or the motion sensor 123c may be the leaf device 120.

According to various embodiments, at least some (for example, the camera 121 and the refrigerator 122) of the leaf device 120 may access the cloud network 140 through the Internet, and a device (for example, the bulb 123a, the digital thermometer 123b, or the motion sensor 123c) which does not support the Internet protocol (IP) in the leaf device 120 may transmit sensed data to a relay device 124 through supported non-IP-based communication (for example, Bluetooth or Zigbee), and the relay device 124 may transmit sensing data of each leaf device 123a, 123b, or 123c to the cloud network 140 through the Internet.

According to various embodiments, the cloud network 140 may include various server devices (for example, an IoT management server and an IoT hub server) which are located in the network and support the cloud computing service in the IoT system 100. The cloud network 140 may perform computing processing for sensing data received from the leaf device 120 and transmit a command for the control of the leaf device 120.

According to various embodiments, the cloud network 140 may perform a function of operating and managing a specific device within the home network to operate as the hub device 110. For example, the cloud network 140 may include an IoT server (for example, an IoT management server or an IoT hub server), and the IoT server may perform the edge computing service of registering, connecting, and managing the leaf device 120 and the hub device 110 and provide modules (for example, a device module and a service module) required for the edge computing service to the hub device 110.

According to various embodiments, the hub device 110 may directly process the data received from the leaf device 120 or transmit the data to the cloud network 140 (for example, the IoT server). The hub device 110 may be a device including hardware and/or software resources required for the edge computing service such as a TV 112 or a tablet PC 111, but is not limited thereto. The hub device 110 may be connected to the cloud network 140 through the Internet and communicate with the leaf device 120 through direct communication, a mesh network, or an access point.

According to various embodiments, a plurality of hub devices 110 may exist within the home network, and the leaf device 120 may be connected to one of the plurality of hub devices 110 to transmit data. For example, the hub device 110 may download modules (for example, the device module and the service module) required for the edge computing service from the cloud network 140 and execute the modules when the specific leaf device 120 is connected.

According to various embodiments, the hub device 110 may perform a unique device function (for example, a video outputting function of the TV) and perform the edge computing service through hardware and/or software resources at least partially simultaneously with the performance of the unique function or for an idle time during which the unique function is not performed.

According to various embodiments, the hub device 110 may store rule information including information for event automation processing. For example, the rule information may be a rule mapping an operation command indicating an operation to be operated by another leaf device in response to a trigger event generated in a specific leaf device. The hub device 110 may receive rule information from the cloud network 140 and construct database in a memory of the hub device 110.

According to various embodiments, the user device 130 may provide various user interfaces related to the edge computing service through an application. For example, the user device 130 may display data (for example, camera video streaming) acquired by the leaf device 120 or resultant data (for example, person recognition) obtained by processing the data by the hub device 110 or the cloud network 140 on the display. Further, the user device 130 may receive a user input such as the connection of the hub device 110 and/or the leaf device 120 or server registration and transmit the user input to the cloud network 140.

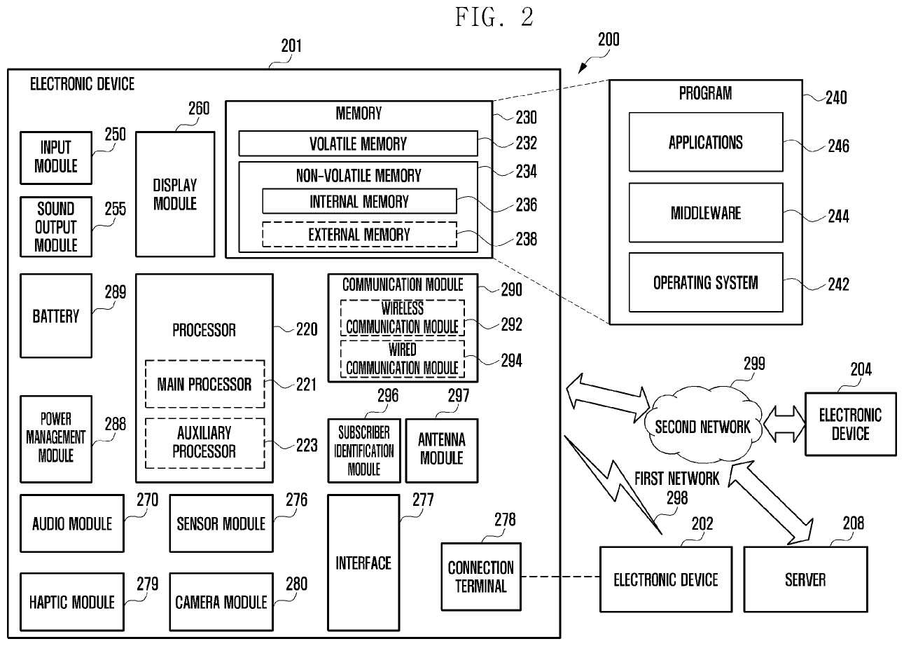

FIG. 2 is a block diagram illustrating an example electronic device 201 in a network environment 200 according to various embodiments. Referring to FIG. 2, the electronic device 201 in the network environment 200 may communicate with an electronic device 202 via a first network 298 (e.g., a short-range wireless communication network), or at least one of an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input 2module 250, a sound output 2module 255, a display 2module 260, an audio module 270, a sensor module 276, an interface 277, a connecting terminal 278, a haptic module 279, a camera module 280, a power management module 288, a battery 289, a communication module 290, a subscriber identification module (SIM) 296, or an antenna module 297. In various embodiments, at least one of the components (e.g., the 22 connecting terminal 278) may be omitted from the electronic device 201, or one or more other components may be added in the electronic device 201. In various embodiments, some of the components (e.g., the sensor module 276, the camera module 280, or the antenna module 297) may be implemented as a single component (e.g., the display module 260). 22

The processor 220 may execute, for example, software (e.g., a program 240) to control at least one other component (e.g., a hardware or software component) of the electronic device 201 coupled with the processor 220, and may perform various data processing or computation. According to an embodiment, as at least part of the data processing or computation, the processor 220 may store a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), or an auxiliary processor 223 (e.g., a graphics processing unit (GPU), a neural processing unit (NPU), an image signal processor (ISP), a sensor hub processor, or a communication processor (CP)) that is operable independently from, or in conjunction with, the main processor 221. For example, when the electronic device 201 includes the main processor 221 and the auxiliary processor 223, the auxiliary processor 223 may be adapted to consume less power than the main processor 221, or to be specific to a specified function. The auxiliary processor 223 may be implemented as separate from, or as part of the main processor 221.

The auxiliary processor 223 may control at least some of functions or states related to at least one component (e.g., the display 2module 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223. According to an embodiment, the auxiliary processor 223 (e.g., the neural processing unit) may include a hardware structure specified for artificial intelligence model processing. An artificial intelligence model may be generated by machine learning. Such learning may be performed, e.g., by the electronic device 201 where the artificial intelligence is performed or via a separate server (e.g., the server 208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input 2module 250 may receive a command or data to be used by another component (e.g., the processor 220) of the electronic device 201, from the outside (e.g., a user) of the electronic device 201. The input 2module 250 may include, for example, a microphone, a mouse, a keyboard, a key (e.g., a button), or a digital pen (e.g., a stylus pen).

The sound output 2module 255 may output sound signals to the outside of the electronic device 201. The sound output 2module 255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 260 may visually provide information to the outside (e.g., a user) of the electronic device 201. The display 2module 260 may include, for example, a display, a hologram device, or a projector and control circuitry to control a corresponding one of the display, hologram device, and projector. According to an embodiment, the display 2module 260 may include a touch sensor adapted to detect a touch, or a pressure sensor adapted to measure the intensity of force incurred by the touch.

The audio module 270 may convert a sound into an electrical signal and vice versa. According to an embodiment, the audio module 270 may obtain the sound via the input 2module 250, or output the sound via the sound output 2module 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, a HDMI connector, a USB connector, a SD card connector, or an audio connector (e.g., a headphone connector).

The haptic module 279 may convert an electrical signal into a mechanical stimulus (e.g., a vibration or a movement) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to an embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device via the first network 298 (e.g., a short-range communication network, such as Bluetooth™, wireless-fidelity (Wi-Fi) direct, or infrared data association (IrDA)) or the second network 299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 292 may identify and authenticate the electronic device 201 in a communication network, such as the first network 298 or the second network 299, using subscriber information (e.g., international mobile subscriber identity (IMSI)) stored in the subscriber identification module 296.

The wireless communication module 292 may include a 5G network and next-generation communication technology after 4G, for example, a new radio (NR) access technology. The NR access technology may support enhanced mobile broadband (eMBB), massive machine type communications (mMTC), or ultra-reliable and low-latency communications (URLLC). The wireless communication module 292 may support a high-frequency band (for example, an mmWave band) in order to achieve, for example, a high data transmission rate. The wireless communication module 292 may support various technologies, for example, beamforming, massive multiple-input and multiple-output (MIMO), full dimensional (FD)-MIMO, array antenna, analog beamforming, or large scale antenna for guaranteeing the performance in the high-frequency band. The wireless communication module 292 may support various requirements defined by the electronic device 201, an external electronic device (for example, the electronic device 204), or the network system (for example, the second network 299). According to an embodiment, the wireless communication module 292 may support a peak data rate (for example, 20 Gbps or higher) for realizing eMBB, loss coverage (for example, 164 dB or lower) for realizing mMTC, or U-plane latency (for example, 0.5 ms or lower in each of downlink (DL) and uplink (UL) or 1 ms of roundtrip or lower) for realizing URLCC.

The antenna module 297 may transmit or receive a signal or power to or from the outside (e.g., the external electronic device) of the electronic device 201. According to an embodiment, the antenna module 297 may include an antenna including a radiating element including a conductive material or a conductive pattern formed in or on a substrate (e.g., a printed circuit board (PCB)). According to an embodiment, the antenna module 297 may include a plurality of antennas (e.g., array antennas). In such a case, at least one antenna appropriate for a communication scheme used in the communication network, such as the first network 298 or the second network 299, may be selected, for example, by the communication module 290 (e.g., the wireless communication module 292) from the plurality of antennas. The signal or the power may then be transmitted or received between the communication module 290 and the external electronic device via the selected at least one antenna. According to an embodiment, another component (e.g., a radio frequency integrated circuit (RFIC)) other than the radiating element may be additionally formed as part of the antenna module 297.

According to various embodiments, the antenna module 297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the electronic devices 202 or 204 may be a device of a same type as, or a different type, from the electronic device 201. According to an embodiment, all or some of operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or mobile edge computing. In an embodiment, the external electronic device 204 may include an internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., smart home, smart city, smart car, or healthcare) based on SG communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or Ir component may be carried out sequentially, in parallel, repeatedly, or heuristically, or one or more of the operations may be executed in a different order or omitted, or one or more other operations may be added.

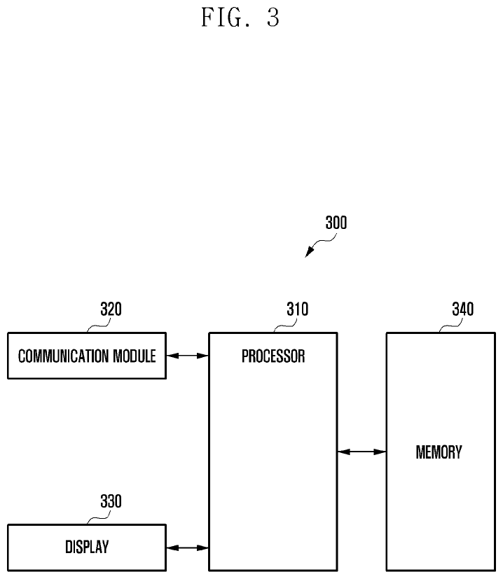

FIG. 3 is a block diagram illustrating an example configuration of the electronic device according to various embodiments.

Referring to FIG. 3, an electronic device 300 may include a communication module (e.g., including communication circuitry) 320, a display 330, a memory 340, and a processor (e.g., including processing circuitry) 310, and various embodiments of the disclosure can be implemented even though some of the illustrated elements are omitted or replaced. The electronic device 300 may further include at least some of the elements and/or functions of the electronic device 201 of FIG. 2.

According to various embodiments, the display 330 may be implemented, for example, and without limitation, as one of a liquid crystal display (LCD), a light-emitting diode (LED) display, or an organic light-emitting diode (OLED) display, but is not limited thereto. The display 330 may be configured as a touch screen which detects a touch and/or a proximity touch (or hovering) input using a user's body part (for example, a finger) or an input device (for example, a stylus pen). The display 330 may include at least some of the elements and/or functions of the display module 260 of FIG. 2. At least a portion of the display 330 may be flexible, and the display 330 may be implemented as a foldable display or a rollable display.

According to various embodiments, the communication module 320 may include various hardware (e.g., circuitry) and/or software components for communication with an external device through a wireless communication network. The communication module 320 may include a cellular communication module supporting cellular wireless communication (for example, 4G and 5G cellular communication) and a short-range wireless communication module (for example, the wireless communication module 292 of FIG. 2) supporting short-range wireless communication (for example, Wi-Fi and Bluetooth). For example, the electronic device 300 may transmit and receive and from data to an external device (or another electronic device) or a cloud server (for example, the cloud network 140 of FIG. 1) through a network using the cellular wireless communication module 320 or the short-range wireless communication module 320.

According to various embodiments, the memory 340 may include a volatile memory and/or a nonvolatile memory to temporarily or permanently store various pieces of data. The memory 340 may include at least some of the elements and/or functions of the memory 130 of FIG. 1 and may store the program 240 of FIG. 2.

According to various embodiments, the memory 340 may store various instructions that can be executed by the processor 310. The instructions may include control command such as arithmetic and logical operations, data movement, and input/output that can be recognized by the processor 310.

According to various embodiments, the processor 310 is an element capable of performing calculations or data processing related to control and/or communication of each element of the electronic device 300 and may include one or more processors (e.g., including processing circuitry). The processor 310 may include at some of the elements and/or functions of the processor 220 of FIG. 2.

According to various embodiments, there is no limitation on a calculation and data processing function that can be implemented in the electronic device 300 by the processor 310, but the disclosure describes various embodiments of receiving IoT control information (or scene data) generated by an external device, converting the IoT control information according to context of the electronic device 300, and storing and using the same.

According to various embodiments, the electronic device 300 may store and execute an application for providing the IoT service. For example, the application may be a SmartThings™ application. The application may display device information of various IoT devices connected through a local network and operation information configured by the user on the display 330 and transmit the device information and the operation information input by the user to the cloud server. Further, the application may display data (for example, camera streaming) acquired from the IoT device or resultant data (for example, person recognition result) obtained by processing the data by the hub device or the cloud server. In addition, the application may provide various user interfaces for providing services such as discovery of each IoT device, function setting, and server onboarding.

According to various embodiments, the processor 310 may generate IoT control information on the basis of a user input. In the disclosure, the IoT control information may be referred to as scene data (or information). The IoT control information may be information configured by the user to control at once a plurality of IoT devices in the local network. For example, the user may configure turning on of the TV in the living room and a light level of the living room as 3 in a cinema mode and may configure operations of various IoT devices in a specific situation, such as closing a curtain, turning on an air cleaner, and stopping a robot cleaner, as one set. The user may configure IoT control information through an application and the configured IoT control information may be stored in the memory 340. When the user activates the corresponding IoT control operation in the application, the operation of each IoT device configured in the IoT control information may be performed.

According to various embodiments, the IoT control information may include user information, device information, and operation information.

According to an embodiment, the user information may include account information registered through the application, personal information (for example, age and sex), and/or user pattern information. The user pattern information may be operation states of various IoT devices stored in several environments (for example, date, time, temperature, and illuminance).

According to an embodiment, the device information may include information on IoT devices configured by the user to operate in the corresponding situation (for example, the cinema mode). For example, the device information may include a name, a model name, a device type, a location, and capability information of each of the TV, the light, the curtain, the air cleaner, and the robot cleaner operating in the cinema mode.

According to an embodiment, the operation information may include the operation configured for each IoT device. For example, the operation of turning on the TV, the operation of controlling a light level of the living room, the operation of closing the curtain, the operation of turning on the air cleaner, and the operation of stopping the robot cleaner in the cinema mode may be included in the operation information.

According to various embodiments, the electronic device 300 may share the registered IoT control information with an external device on the basis of a user input. The external device is a device which is the same type as the electronic device 300 (for example, a user device such as a smartphone or a tablet PC) and may be a device capable of controlling IoT devices by executing the same application (for example, the SmartThings™ application).

According to various embodiments, the processor 310 may provide a GUI through which pre-registered IoT control information can be shared with an external device in the application, and transmit the IoT control information to the external device according to user selection in the GUI. According to an embodiment, the electronic device 300 may transmit configured IoT control information to the cloud server, and the cloud server may transmit the IoT control information to the external device.

Hereinafter, an operation in which the electronic device 300 receives IoT control information generated by the external device, converts the IoT control information into IoT control information of the electronic device 300, and registers the same is described.

According to various embodiments, the electronic device 300 may receive first IoT control information generated by an external device through the communication module 320. The first IoT control information may be directly received from the external device or received from the cloud server. The first IoT control information may include device information of at least one IoT device and operation information configured for each IoT device.

According to various embodiments, the processor 310 may select at least one IoT device from among the devices which can be connected in the local network of the electronic device 300 on the basis of the received first IoT operation information. The processor 310 may identify IoT devices within the local network registered through the application and select an IoT device corresponding to device information of the IoT device included in the first IoT operation information among the identified IoT devices.

According to various embodiments, the processor 310 may determine one of the devices which can be connected in the local network of the electronic device 300 as a main device.

According to an embodiment, the processor 310 may determine one of the IoT devices which are the same type as the device information of the external IoT device of the first IoT control information among at least one IoT device which can be connected in the local network as a main device. For example, when the TV is registered as the main device in the first IoT control information, the processor 310 may determine the TV which is the same type among the IoT devices within the local network as the main device.

According to an embodiment, when there is no IoT device which is the same type as the device information of the external IoT device of the first IoT control information among at least one IoT device which can be connected in the local network, the processor 310 may analyze configured text in the first IoT control information and determine a main device suitable therefor. For example, when a title of the first IoT information is configured as a cinema mode, the TV which is most important to view a cinema may be determined as the main device. According to an embodiment, the processor 310 may determine the main device on the basis of user pattern information stored in the memory 340.

According to various embodiments, when the capability of the determined main device (or sub device) is different from the capability of the external IoT device, the processor 310 may change operation information of the first IoT control information on the basis of the capability of the determined main device and determine operation information of second IoT control information. For example, when the TV registered by the external IoT device supports volume levels from 1 to 30, the volume level is configured as 15 in a cinema mode, and the TV of the user determined as the main device support volume levels from 1 to 20, the volume in the cinema mode may be configured as 10. Alternatively, when the light registered by the external IoT device supports illuminance of various levels and the light of the local network of the electronic device supports only on/off, operation information to be applied to the light in the cinema mode may be configured as turning-on.

According to various embodiments, the processor 310 may determine the main device among at least one IoT device pre-registered through the application. When an IoT device corresponding to device information of the first IoT control information is not pre-registered, the IoT device corresponding to device information of the first IoT control information may be configured to be discovered in the local network. When a specific IoT device is discovered and may operate as the main device (or sub device), the processor 310 may onboard information on the corresponding device in the cloud server.

According to various embodiments, the processor 310 may determine the main device and then determine at least one sub device capable of operating with the main device. According to an embodiment, the processor 310 may determine sub devices on the basis of location information of the main device. For example, when the TV, the living room light, the living room curtain, and the air cleaner are configured as device information of the first IoT control information and the TV located in the bedroom is determined as the main device, the processor 310 may determine the light, the curtain, and the air cleaner located in the bedroom that is the same place where the TV is located as the sub devices. The processor 310 may change operation information of the selected sub devices on the basis of capabilities of the sub devices.

According to various embodiments, when there is no device which is the same type as the device of the first IoT control information, the processor 310 may select an IoT device capable of performing a corresponding function as the main device or the sub device. For example, when the first IoT control information includes an air cleaner and there is no air cleaner in a user environment, an air conditioner capable of performing a similar function as that of the air cleaner may be selected and an operation in a clean mode may be configured as operation information of the air conditioner.

According to various embodiments, when a plurality of devices capable of operating as the main devices are identified, the processor 310 may provide a menu for selecting one of the plurality of IoT devices through an application. For example, when the TV is determined as the main device on the basis of the first IoT control information and there are two TVs within the local network, a menu for selecting one of the two TVs may be provided and the main device may be determined according to user selection. The processor 310 may determine a sub device among the devices positioned in the same location where the selected main device is positioned.

According to various embodiments, the processor 310 may generate second IoT operation information on the basis of the selected main device and sub devices, and operation information configured for each device. The processor 310 may store the second IoT operation information in the memory 340 and transmit the same to the cloud server. The processor 310 may display a UI object indicating the second IoT operation information in the application, and the operation of each IoT device configured in the second IoT operation information may be activated according to selection of the UI object.

According to various embodiments, when the first IoT operation information is received or the second IoT information is generated, the processor 310 may provide a notification through the display 330.

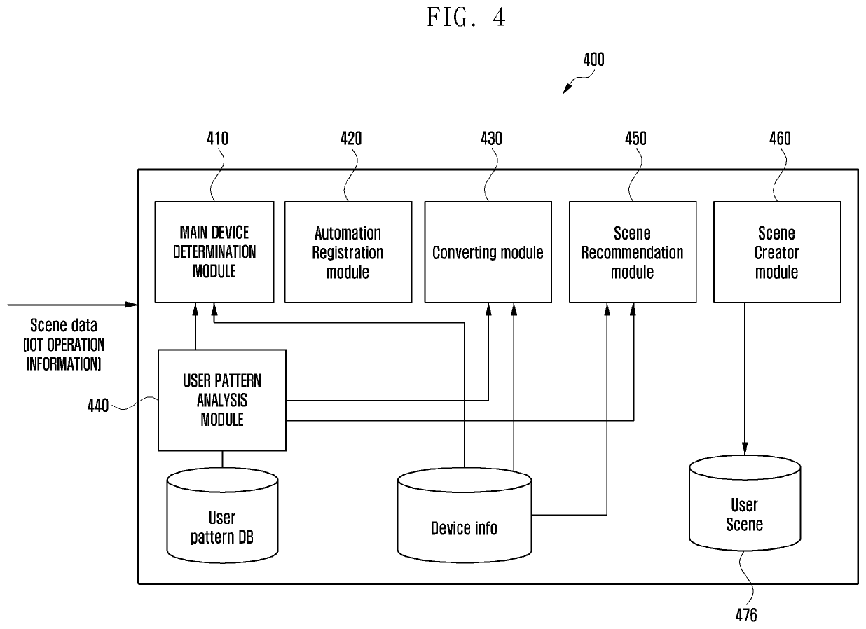

FIG. 4 is a diagram illustrating an example system architecture for IoT control information of an electronic device according to various embodiments.

According to various embodiments, an electronic device 400 (for example, the electronic device 300 of FIG. 3) may generate second IoT control information including operation information of the IoT device of the local network on the basis of the first IoT control information shared by the external device. The electronic device 400 may include a scene creator module 460, a main device determination module 410, an automation registration module 420, a converting module 430, a scene recommendation module 450, and a user pattern analysis module 440 as elements for generating second IoT control information as illustrated in FIG. 4. Each of the illustrated elements may include a software module (e.g., including various processing circuitry and/or executable program instructions) and may be configured by a set of instructions which can be executed by the processor.

According to various embodiments, the main device determination module 410 may determine one of the devices which can be connected in the local network as a main device on the basis of first IoT control information received from the external device.

According to an embodiment, when there is a device which is the same type as the device information of the first IoT control information, the main device determination module 410 may determine one of the devices which are the same type as the main device.

According to an embodiment, when there is no device which is the same type in the local network, the main device determination module 410 may select a device which other users frequently use in a similar situation. The main device determination module 410 may perform a keyword search for text (for example, a scene title) configured in the first IoT control information in big data and determine a frequently used device as the main device. For example, a device which can be appropriately used for the corresponding situation may be determined as the main device through analysis of text such as a cinema, music, or food input as the title of the first IoT control information.

According to an embodiment, the main device determination module 410 may determine the main device by comparing device information of the user of the electronic device 400 (for example, device information registered in the application, device location information, device type information, or capability) with a scene received through the user pattern analysis module 440.

According to various embodiments, the converting module 430 may convert device information and operation information of the first IoT control information to generate second IoT control information. According to an embodiment, when the main device is selected, the converting module 430 may convert device information and operation information on the basis of location information of the main device and a user pattern analyzed through the user pattern analysis module 440.

According to various embodiments, the scene creator module 460 may display the second IoT control information converted and generated by the converting module 430 through the application. For example, the scene creator module 460 may display a UI object indicating the second IoT control information through the application and store the same in a user scene DB 476 on the basis of user selection.

According to various embodiments, the scene recommendation module 450 may recommend a plurality of pieces of IoT control information which can be used to the user on the basis of device information registered in the application by the user. For example, when the user registers the TV, the air conditioner, and the air cleaner located within the home through the application, IoT control information which can be made using the three devices may be recommended to the user. Further, the scene recommendation module 450 may analyze a usage history pattern of the user for each IoT device and recommend IoT control information. For example, when a user's action of viewing the TV and turning off the light at a specific time is repeatedly detected, IoT control information including the operation of turning on the TV and turning off the light at the corresponding time may be recommended.

According to various embodiments, when there is no device which is the same type as the device of the received first IoT control information in the IoT devices registered through the application, the automation registration module 420 may perform discovery to identify another device located within the home. When a specific IoT device is discovered and may perform a corresponding operation, information on the corresponding device may be onboarded in the cloud server.

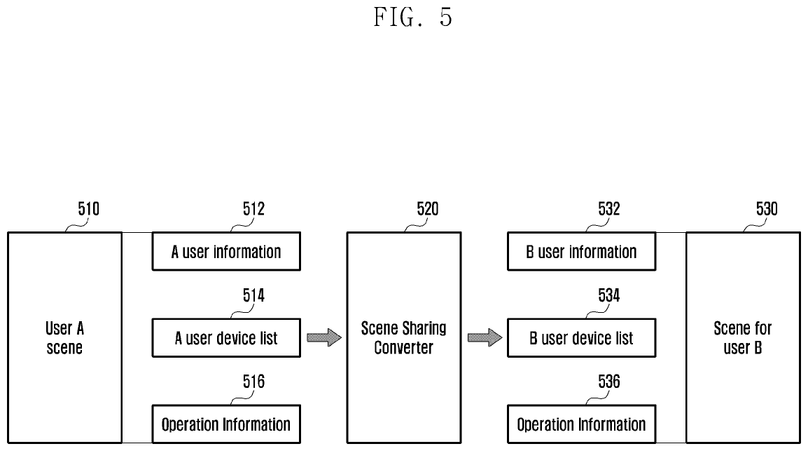

FIG. 5 is a diagram illustrating an example of sharing and converting IoT control information according to various embodiments.

According to various embodiments, user A may share first IoT control information 510 which user A registered with an electronic device (for example, the electronic device 300 of FIG. 3) of user B. Referring to FIG. 5, the first IoT control information 510 may include user information 512, a device list 514, and operation information 516.

According to an embodiment, the user information 512 may include account information (user ID) registered through the application, location information, personal information (for example, age or sex), and/or user pattern information. The user pattern information may be operation states of various IoT devices stored in several environments (for example, date, time, temperature, and illumination).

According to an embodiment, the device information 514 may include a list of IoT devices configured to operate in the corresponding situation (for example, the cinema mode) by the user. For example, the device information 514 may include a name, a model name, a device type, a location, (for example, information on a room in which the IoT device is located), and capability information of each of the TV, the light, the curtain, the air cleaner, and the robot cleaner operating in the cinema mode.

According to an embodiment, the operation information 516 may include an operation configured for each IoT device. For example, the operation of turning on the TV, the operation of controlling a light level of the living room, the operation of closing the curtain, the operation of turning on the air cleaner, and the operation of stopping the robot cleaner in the cinema mode may be included in the operation information.

According to various embodiments, the scene converting module 520 may convert the device information 514 and the operation information 516 of the first IoT control information 510 to generate second IoT control information 530. Referring to FIG. 5, the second IoT control information 530 may include user information 532 of user B, device information 534, and operation information 536.

According to an embodiment, the user information may be changed from the user information 512 of user A to the user information 532 of user B. The device information may be changed to device information of devices selected from the IoT devices in the local network of user B by the scene converting module 520. The operation of each device of the first IoT control information 510 may be equally applied to the operation information, but some of the operation information may be changed in consideration of the capability of each IoT device of user B.

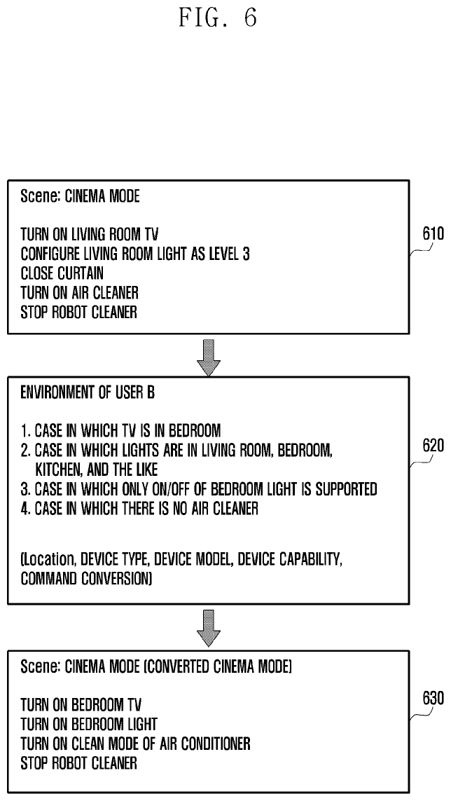

FIG. 6 is a diagram illustrating an example method of converting IoT control information according to various embodiments.

Referring to FIG. 6, first IoT control information 610 in the cinema mode may be generated by user A. For example, device information of the first IoT control information may include device information of the living room TV, the living room light, the curtain, the air cleaner, and the robot cleaner, and the operation information may include turning on the living room TV, configuring the living room light as 3, closing the curtain, turning on the air cleaner, and stopping the robot cleaner.

Referring to FIG. 6, in an environment 620 of user B, the TV may be located in the bedroom, the lights are located in the living room, the bedroom, and the kitchen, only on/off of the bedroom light is supported, and there may be no air cleaner.

According to various embodiments, the electronic device receiving the first IoT control information may change device information and/or the operation information of the first IoT control information according to the environment of user B to generate the second IoT control information 630. When user A shares IoT control information with user B, the electronic device may change the received IoT control information according to the environment of user B because types and manufacturers of devices installed in the home of user B may be all different.

Referring to FIG. 5, the electronic device selects the TV as the main device of the cinema mode but there is only the TV located in the bedroom in the environment of user B, and thus the bedroom TV may be determined. In this case, the electronic device may determine the TV as the main device through text indicating the cinema mode configured as a title of the first IoT control information, identify the TV located in the living room in the environment of user B, and then identify there is no TV of which the location is registered as the living room and register the bedroom TV as the main device.

The electronic device may select the bedroom light and the robot cleaner registered to have the same location as the bedroom TV which is the selected main device as sub devices. Further, since there is no device which is the same type as the air cleaner of the first IoT control information in the environment of user B, the electronic device may select the air conditioner which can perform a similar function as the sub device. Accordingly, the converted second IoT control information may include turning on the bedroom TV, turning on the bedroom light, turning on a clean mode of the air conditioner, and stopping the robot cleaner.

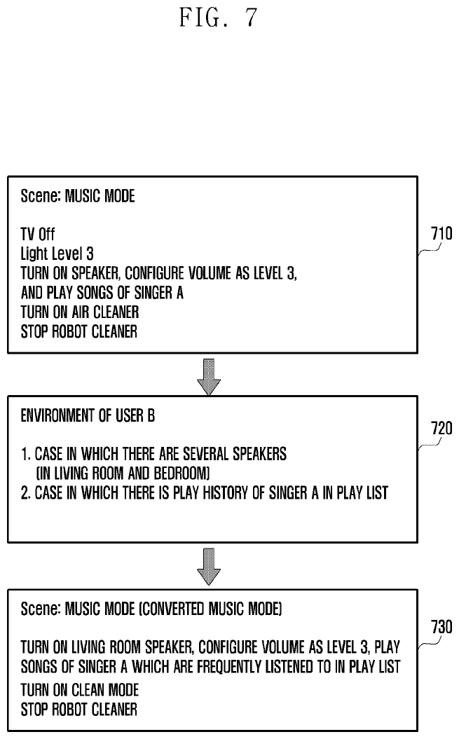

FIG. 7 is a diagram illustrating an example method of converting IoT control information according to various embodiments.

Referring to FIG. 7, first IoT control information 710 of a music mode may be generated by user A. For example, device information of the first IoT control information may be the TV, the light, the speaker, the air cleaner, and the robot cleaner, and the operation information may include turning off the TV, configuring a light level as 3, turning on the speaker, playing a song of singer A at volume 3, turning on the air cleaner, and stopping the robot cleaner.

Referring to FIG. 7, in an environment 720 of user B, there may be a plurality of speakers located in the living room and the bedroom and there may be a playback history for songs of singer A in a play list.

According to various embodiments, the electronic device receiving the first IoT control information may change device information and/or the operation information of the first IoT control information according to the environment of user B to generate the second IoT control information 730. In this case, when determining the main device, the electronic device may determine the speaker as the main device through the music mode which is the title of the first IoT control information. Since there is the living room speaker and the bedroom speaker in the environment of user B, the electronic device may provide a menu for selecting one thereof as the main device through the application.

When the living room speaker is selected as the main device according to a user input, the electronic device may analyze a usage history of the living speaker and select a song of singer A which is frequently listened to in the play list. Further, the electronic device may select the air cleaner and the robot cleaner in the same location as the living room speaker and apply the same operation information.

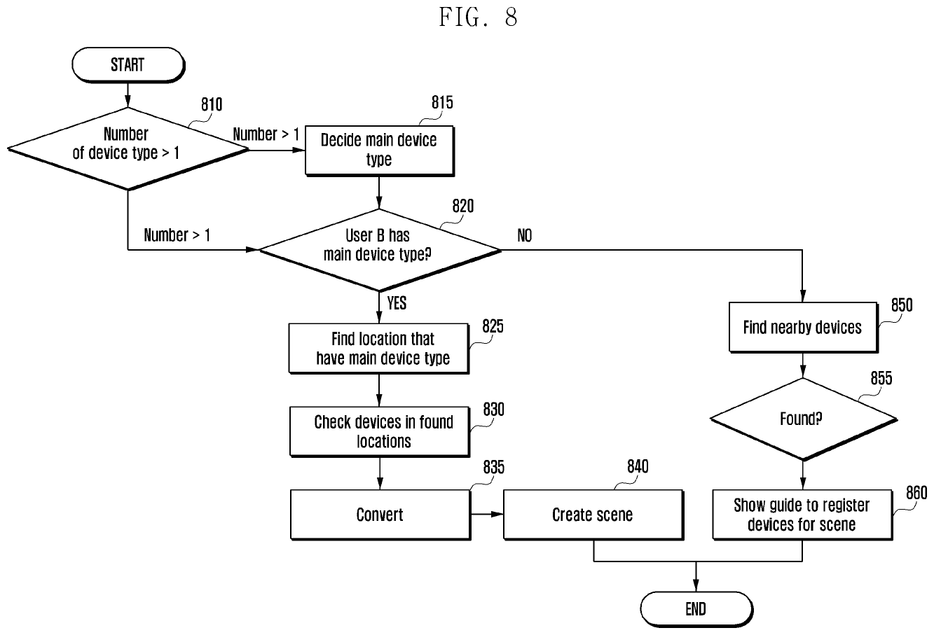

FIG. 8 is a flowchart illustrating an example method of sharing IoT control information according to various embodiments.

The illustrated method may be performed by the electronic device (for example, the electronic device 300 of FIG. 3) described above through FIGS. 3 to 7, that is, an electronic device which may receive first IoT control information from an external device and convert the same to second IoT control information.

According to various embodiments, in operation 810, the electronic device may identify whether the number of IoT devices registered as device information in the first IoT control information received from the external device is plural. When the number of IoT devices is plural, the electronic device may determine a type of a main device in operation 815. For example, the type (for example, TV) of the main device may be determined on the basis of text (for example, a cinema mode) such as a title registered in the first IoT control information. When the number of IoT devices registered as the device information in the first IoT control information is 1, the electronic device may determine a type of the corresponding IoT device as the type of the main device in operation 820.

According to various embodiments, in operation 820, the electronic device may identify whether there is a device corresponding to the determined type of the main device among IoT devices in the local network registered by the user. When the device corresponding to the type of the main device is identified (Yes in operation 820), the corresponding device may be determined as the main device and a location of the determined main device (for example, room or living room) may be identified in operation 825. In operation 830, the electronic device may identify another device registered to have the same location as the location of the main device and determine a device which is the same type as the device information of the first IoT control information among the identified devices as a sub device.

According to various embodiments, the electronic device may change the first IoT control information according to the identified main device and sub device in operation 835, and generate second IoT control information in operation 840.

According to various embodiments, when there is no device corresponding to the type of the determined main device among the IoT devices in the local network registered by the user on the basis of the identification result of operation 820, the electronic device may discover another adjacent device in operation 850.

When another device is identified in operation 855, the electronic device may display a menu for guiding the identified device to be registered in the second IoT control information in the application in operation 860.

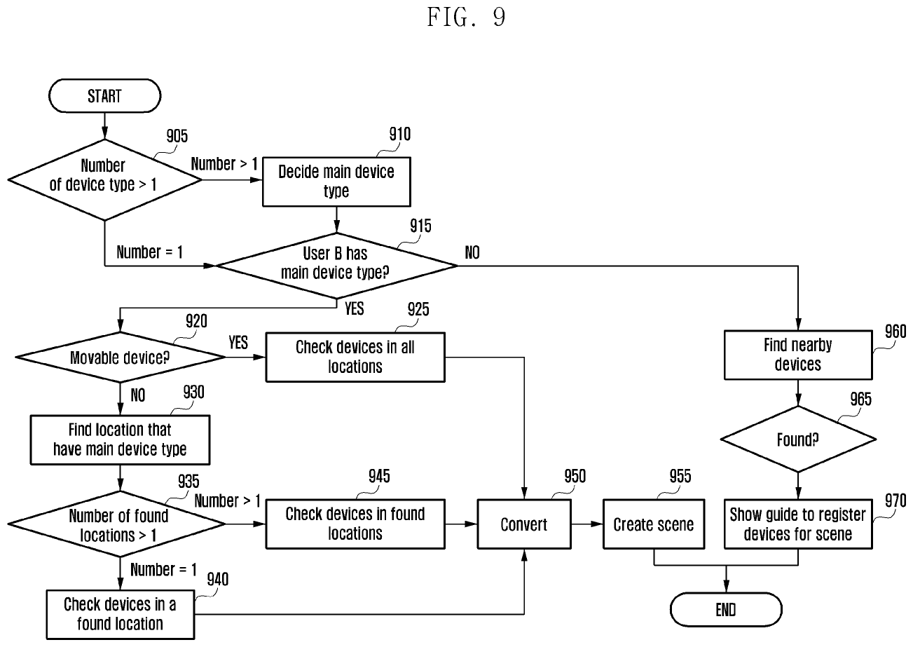

FIG. 9 is a flowchart illustrating an example method of sharing IoT control information according to various embodiments.

According to various embodiments, in operation 905, an electronic device (for example, the electronic device of FIG. 3) may identify whether the number of IoT devices registered as device information in the first IoT control information received from the external device is plural. When the number of IoT devices is plural, the electronic device may determine a type of a main device in operation 910. For example, the type (for example, TV) of the main device may be determined on the basis of text (for example, a cinema mode) such as a title registered in the first IoT control information. When the number of IoT devices registered as the device information in the first IoT control information is 1, the electronic device may determine a type of the corresponding IoT device as the type of the main device in operation 915.

According to various embodiments, when the type of the main device is determined, the electronic device may identify whether the corresponding type is a type of a movable device (for example, a robot cleaner) in operation 920. When the type is the type of the movable device, the electronic device may identify all connectable IoT devices located in the home in operation 925.

According to various embodiments, when the type is not the type of the movable device (for example, TV, curtain, or light) on the basis of the identification result of operation 920, the location of the device of the corresponding type may be identified in the home in operation 930. In operation 935, the electronic device may identify whether the number of identified locations is plural. When the number of identified locations is 1, an IoT device at the corresponding location may be identified in operation 940 and, and when the number of identified locations is plural, all IoT devices at the identified locations may be identified in operation 945.

According to various embodiments, in operation 950, the first IoT control information may be changed on the basis of the device information of the identified IoT device. For example, the electronic device may determine one of the connectable IoT devices as the main device, determine at least one IoT device positioned at the same location as the determined main device as sub devices, and determine operation information of the determined main device and sub devices on the basis of operation information of each device of the first IoT control information. In this case, when the determined main device is a movable device (for example, a robot cleaner), devices which are the same type as the device included in the first IoT control information at all location within the home may be determined as the sub devices. In operation 955, the electronic device may convert the first IoT control information to generate second IoT control information.

According to various embodiments, when there is no device corresponding to the type of the determined main device among the IoT devices in the local network registered by the user on the basis of the identification result of operation 915, the electronic device may discover another adjacent device in operation 960.

When another device is identified in operation 965, the electronic device may display a menu for guiding the identified device to be registered in the second IoT control information in the application in operation 970.

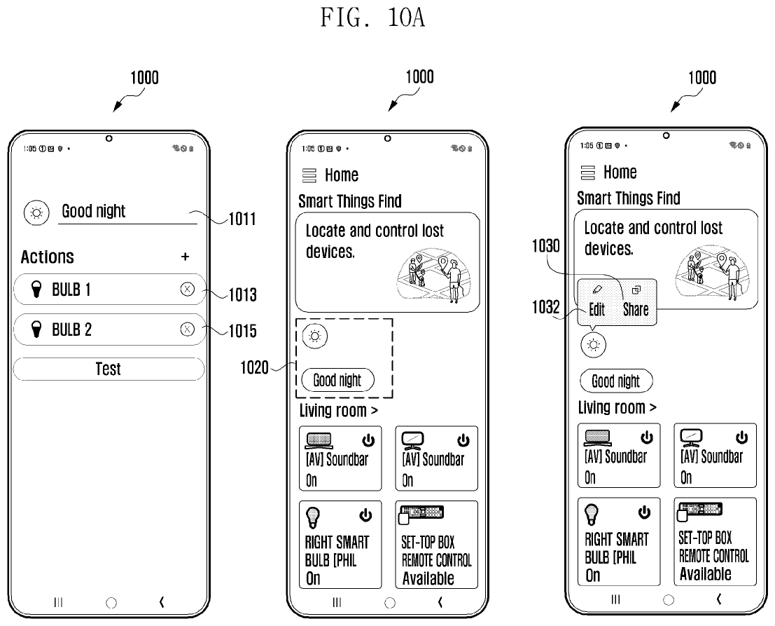

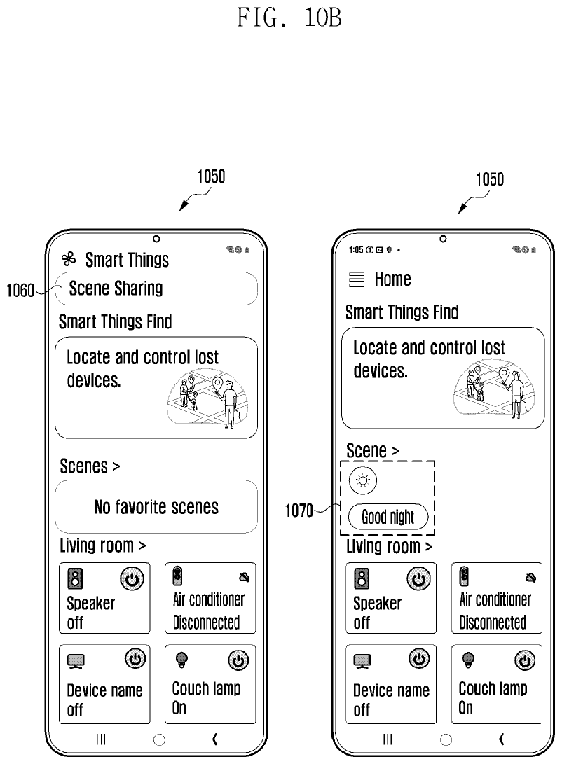

FIGS. 10A and 10B are diagrams illustrating example application screens of an electronic device for controlling IoT devices according to various embodiments.

FIG. 10A illustrates an execution screen of an application (for example, SmartThings™) which generates IoT control information (or scene data) in the electronic device.

According to various embodiments, the application of the electronic device may provide a menu for registering IoT control information. For example, the electronic device may configure a name 1011 of IoT control information, device information, and operation information according to a user input.

According to various embodiments, the electronic device may display items 1013 and 1015 indicating the generated IoT control information in the application and activate/deactivate an operation of each IoT device registered in the IoT control information according to a user input for the item 1013 or 1015.

According to various embodiments, the electronic device may share the IoT control information with another device. For example, when a predetermined input (for example, a long touch) for an item 1020 indicating IoT control information is input in the application, an edit item 1032 for editing the IoT control information and a sharing item 1030 for sharing with another device may be displayed. When the sharing item 1030 is selected according to a user input, the corresponding IoT control information may be shared with another electronic device.

FIG. 10B illustrates an execution screen 1050 of an application when the electronic device receives IoT control information from an external device.

Referring to FIG. 10B, when receiving IoT control information from an external device, the electronic device may display a notification indicating the reception of the IoT control information in the form of a popup.

According to various embodiments, it is possible to generate new IoT control information by changing device information and operation information of the received IoT control information according to an environment of the user of the electronic device. When the new IoT control information is generated, the electronic device may display an item 1060 indicating that the IoT control information has been shared and an item 1070 indicating the shared IoT control information, and activate/deactivate an operation of each IoT device registered in the IoT control information according to a user input for the item 1070.

An electronic device according to various example embodiments may include: a display, a communication module comprising communication circuitry, a memory, and a processor operatively connected to the display, the communication module, and the memory, wherein the processor may be configured to: receive first Internet of things (IoT) control information including device information of at least one external IoT device generated by an external device and operation information configured for the at least one external IoT device through the communication module, identify at least one IoT device which can be connected in a local network through the electronic device, determine a main device among the at least one identified IoT device and operation information to be applied to the main device based on the received first IoT control information, and generate second IoT control information including device information of the main device and operation information of the main device.

According to various example embodiments, the processor may be configured to determine at least one sub device among the at least one identified IoT device and operation information to be applied to the at least one sub device on the basis of the first IoT control information.

According to various example embodiments, the processor may be configured to: identify location information of the determined main device and determine at least one IoT device registered to have location information equal to that of the main device as the at least one sub device.

According to various example embodiments, the processor may be configured to determine, as the main device, one of IoT devices of a type equal to device information of an external IoT device of the first IoT control information among the at least one IoT device which can be connected in the local network.

According to various example embodiments, the processor may be configured to, based on a capability of the determined main device being different from a capability of the external IoT device, change operation information of the first IoT control information, based on the capability of the determined main device and determine operation information of the second IoT control information.

According to various example embodiments, the processor may be configured to store user pattern information for the at least one IoT device in the local network in the memory and determine the main device, based on the stored user pattern information.

According to various example embodiments, the processor may be configured to, based on there being no IoT device of a type equal to device information of an external IoT device of the first IoT control information among the at least one IoT device which can be connected in the local network, determine one of the at least one IoT device of the local network as the main device, based on text configured for the first IoT control information.

According to various example embodiments, the processor may be configured to determine the main device among at least one pre-registered IoT device through an application.

According to various example embodiments, the processor may be configured to, based on an IoT device corresponding to device information of the first IoT control information not being pre-registered, discover the IoT device corresponding to the device information of the first IoT control information in the local network.

According to various example embodiments, the processor may be configured to, based on identifying that a number of IoT devices which can operate as the main device among the at least one IoT device which can be connected in the local network is plural, provide a menu for selecting one of the plurality of IoT devices through the display.

According to various example embodiments, the processor may be configured to, based on the first IoT operation information being received and/or the second IoT operation information being generated, provide a notification through the display.

According to various example embodiments, the processor may be configured to receive the first IoT operation information from the external user device or a cloud server through the communication module.

A method of converting IoT control information shared with an external device by an electronic device according to various example embodiments may include: receiving first Internet of things (IoT) control information including device information of at least one external IoT device generated by an external user device and operation information configured for the at least one external IoT device, identifying at least one IoT device which can be connected in a local network through the electronic device, determining a main device among the at least one identified IoT device and operation information to be applied to the main device based on the received first IoT control information, and generating second IoT control information including device information of the main device and operation information of the main device.

According to various example embodiments, the method may further include determining at least one sub device among the at least one identified IoT device and operation information to be applied to the at least one sub device, based on the first IoT control information.

According to various example embodiments, the determining the at least one sub device may include: identifying location information of the determined main device and determining at least one IoT device registered to have location information equal to that of the main device as the at least one sub device.

According to various example embodiments, the determining the main device may include determining, as the main device, one of IoT devices of a type equal to device information of an external IoT device of the first IoT control information among the at least one IoT device which can be connected in the local network.

According to various example embodiments, the determining the main device and the operation information may include: based on a capability of the determined main device being different from a capability of the external IoT device, changing operation information of the first IoT control information, based on the capability of the determined main device and determining operation information of the second IoT control information.

According to various example embodiments, the determining the main device may include: based on there being no IoT device of a type equal to device information of an external IoT device of the first IoT control information among the at least one IoT device which can be connected in the local network, determining one of the at least one IoT device of the local network as the main device, based on text configured for the first IoT control information.

According to various example embodiments, the determining the main device may include determining the main device among at least one pre-registered IoT device through an application.

According to various example embodiments, the method may further include based on an IoT device corresponding to device information of the first IoT control information not being pre-registered, discovering the IoT device corresponding to the device information of the first IoT control information in the local network.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
a communication module comprising communication circuitry;
a memory; and
a processor operatively connected to the display, the communication module, and the memory,
wherein the processor is configured to:
receive first Internet of things (IoT) control information comprising device information of at least one external IoT device generated by an external device and operation information configured for the at least one external IoT device through the communication module;
identify at least one IoT device which can be connected in a local network through the electronic device;
determine a main device among the at least one identified IoT device and operation information to be applied to the main device based on the received first IoT control information; and
generate second IoT control information comprising device information of the main device and operation information of the main device.

2. The electronic device of claim 1, wherein the processor is configured to determine at least one sub device among the at least one identified IoT device and operation information to be applied to the at least one sub device based on the first IoT control information.

3. The electronic device of claim 2, wherein the processor is configured to:
identify location information of the determined main device; and
determine at least one IoT device registered to have location information equal to that of the main device as the at least one sub device.

4. The electronic device of claim 1, wherein the processor is configured to determine, as the main device, one of IoT devices of a type equal to device information of an external IoT device of the first IoT control information among the at least one IoT device which can be connected in the local network.

5. The electronic device of claim 4, wherein the processor is configured to based on a capability of the determined main device being different from a capability of the external IoT device, change operation information of the first IoT control information based on the capability of the determined main device and to determine operation information of the second IoT control information.

6. The electronic device of claim 1, wherein the processor is configured to:
store user pattern information for the at least one IoT device in the local network in the memory; and
determine the main device based on the stored user pattern information.

7. The electronic device of claim 1, wherein the processor is configured to, based on there being no IoT device of a type equal to device information of an external IoT device of the first IoT control information among the at least one IoT device which can be connected in the local network, determine one of the at least one IoT device of the local network as the main device based on text configured for the first IoT control information.

8. The electronic device of claim 1, wherein the processor is configured to determine the main device among at least one pre-registered IoT device through an application.

9. The electronic device of claim 8, wherein the processor is configured to, based on an IoT device corresponding to device information of the first IoT control information not being pre-registered, discover the IoT device corresponding to the device information of the first IoT control information in the local network.

10. The electronic device of claim 1, wherein the processor is configured to, based on identifying that a number of IoT devices which can operate as the main device among the at least one IoT device which can be connected in the local network is plural, provide a menu for selecting one of the plurality of IoT devices through the display.

11. The electronic device of claim 1, wherein the processor is configured to, based on the first IoT operation information being received and/or the second IoT operation information being generated, provide a notification through the display.

12. The electronic device of claim 1, wherein the processor is configured to receive the first IoT operation information from the external device or a cloud server through the communication module.

13. A method of converting IoT control information shared with an external device by an electronic device, the method comprising:
receiving first Internet of things (IoT) control information comprising device information of at least one external IoT device generated by an external device and operation information configured for the at least one external IoT device;
identifying at least one IoT device which can be connected in a local network through the electronic device;
determining a main device among the at least one identified IoT device and operation information to be applied to the main device based on the received first IoT control information; and
generating second IoT control information comprising device information of the main device and operation information of the main device.

14. The method of claim 13, further comprising determining at least one sub device among the at least one identified IoT device and operation information to be applied to the at least one sub device based on the first IoT control information.

15. The method of claim 14, wherein the determining of the at least one sub device comprises:
identifying location information of the determined main device; and
determining at least one IoT device registered to have location information equal to that of the main device as the at least one sub device.

16. The method of claim 13, wherein the determining of the main device comprises:
determining, as the main device, one of IoT devices of a type equal to device information of an external IoT device of the first IoT control information among the at least one IoT device which can be connected in the local network.

17. The method of claim 16, wherein the determining of the operation information to be applied to the main device comprises:
based on a capability of the determined main device being different from a capability of the external IoT device, changing operation information of the first IoT control information based on the capability of the determined main device and determining operation information of the second IoT control information.

18. The method of claim 13, wherein the determining of the main device comprises:
based on there being no IoT device of a type equal to device information of an external IoT device of the first IoT control information among the at least one IoT device which can be connected in the local network, determining one of the at least one IoT device of the local network as the main device based on text configured for the first IoT control information.

19. The method of claim 13, wherein the determining of the main device comprises:
determining the main device among at least one pre-registered IoT device through an application.

20. The method of claim 19, further comprising:
based on an IoT device corresponding to device information of the first IoT control information not being pre-registered, discovering the IoT device corresponding to the device information of the first IoT control information in the local network.
